(19) United States
(12) Patent Application Publication
(10) Pub. No.: US 2018/0175512 A1
(43) Pub. Date: Jun. 21, 2018

(54) PRINTED WIRING BOARD WITH RADIATOR AND FEED CIRCUIT

(71) Applicant: Raytheon Company, Waltham, MA (US)

(72) Inventor: Robert S. Isom, Allen, TX (US)

(73) Assignee: Raytheon Company, Waltham, MA (US)

(21) Appl. No.: 15/379,761

(22) Filed: Dec. 15, 2016

(51) Int. Cl. H01Q 21/06; H01Q 1/38; H01Q 21/28; H01Q 1/42; H01Q 1/48; H01Q 21/22; H01Q 9/04

(52) U.S. Cl. CPC H01Q 21/062; H01Q 1/38; H01Q 21/28; H01Q 9/0428; H01Q 1/48; H01Q 21/22; H01Q 1/42

(57) ABSTRACT

In one aspect, a unit cell of a phased array antenna includes a printed wiring board (PWB). The PWB includes a first layer comprising a radiator, a second layer comprising a feed circuit configured to provide excitation signals to the radiator, a plurality of vias connecting the feed circuit to the radiator, a signal layer, an active component layer comprising an active component bonded to the signal layer and a radio frequency (RF) connector connecting the signal layer to the feed circuit.

### BACKGROUND

Performance of an array antenna is often limited by the size and bandwidth limitations of the antenna elements which make up the array. Improving the bandwidth while maintaining a low profile enables array system performance to meet bandwidth and scan requirements of next generation of communication applications, such as software defined or cognitive radio. These applications also frequently require antenna elements that can support either dual linear or circular polarizations.

### SUMMARY

In one aspect, a unit cell of a phased array antenna includes a printed wiring board (PWB). The PWB includes a first layer comprising a radiator, a second layer comprising a feed circuit configured to provide excitation signals to the radiator, a plurality of vias connecting the feed circuit to the radiator, a signal layer, an active component layer comprising an active component bonded to the signal layer and a radio frequency (RF) connector connecting the signal layer to the feed circuit.

In another aspect, a unit cell of a phased array antenna includes a printed wiring board (PWB). The PWB includes a first layer comprising a radiator that includes a first dipole arm, a second dipole arm, a third dipole arm and a fourth dipole arm. The PWB also includes a second layer that includes a quadrature feed circuit configured to provide excitation signals to the radiator using right hand circular polarization (RHCP). The PWB further includes a first via coupled to the first dipole arm, a second via coupled to the second dipole arm, a third via coupled to the third dipole arm, a fourth via coupled to the fourth dipole arm, wherein the first, second, third and fourth vias provide the excitation signal from the feed circuit, a fifth via coupled to the first dipole arm, a sixth via coupled to the second dipole arm, a seventh via coupled to the third dipole arm and an eighth via coupled to the fourth dipole arm, wherein the fifth, sixth, seventh and eighth vias provide ground. The PWB still further includes a third layer between the first and second layers, wherein the third layer comprises a dielectric having four rounded corners evenly spaced around the dialectic.

In a further aspect, a unit cell of a phased array antenna includes a first means for providing a radiated signal, a second means for generating excitation signals and a third means for providing the excitation signals from the second means to the first means.

### DESCRIPTION OF THE DRAWINGS

FIG. 1A is a diagram of an example of a phased antenna array.

FIG. 1B is a diagram of an example of a unit cell of the phased array antenna.

FIG. 2A is a diagram of an example, of a side view of the unit cell of FIG. 1B.

FIG. 2B is a diagram of an example of a bottom view of the unit cell of FIG. 1B.

FIG. 2C is a diagram of an example of a top view of the unit cell of FIG. 1B.

FIG. 3 is a detailed diagram of an example of layers around a feed layer of FIG. 2A.

FIG. 4 is a diagram of a bottom view of one example of a backdrill and a corresponding via.

FIG. 5 is a diagram of an example of a printed wiring board (PWB).

FIG. 6A is a diagram of an example of realized gain versus angle for a patch radiator.

FIG. 6B is a diagram of an example of realized gain versus angle for a current loop radiator.

FIG. 7A is a diagram of an example of axial ratio versus angle for the patch radiator.

FIG. 7B is a diagram of an example of axial ratio versus angle for a current loop radiator.

FIG. 8 is a diagram of another example of a feed circuit.

### DETAIL DESCRIPTION

Described herein is a phased array antenna that includes one or more unit cells. A unit cell includes a printed wiring board (PWB) that includes a radiator on a single layer of the PWB and a feed circuit on a single layer of the PWB. In one example, the radiator is a current loop radiator.

Current loop radiators described herein use low-cost materials compatible with FR4 processing thereby eliminating the need for higher cost materials to achieve performance over frequency and scan. Bandwidth in terms of frequency and scan volume can be improved in radiators by designing them with lower dielectric materials that are closer to air. But these materials typically result in increased material costs and/or fabrication complexity. Radiating structures that are naturally low-Q, high bandwidth, such as the current loop described herein, offer improved performance compared to elements such as the patch radiator that have inherently higher-Q and have less bandwidth. The current loop radiator designed for air instead of a dielectric has a bandwidth of more than 8:1 in both single and dual-polarized configurations. A current loop radiator described herein with a higher dielectric constant material achieves better axial ratio and insertion loss performance over scan and at a wider frequency bandwidth than was achieved with the previous patch radiator designs. The current loop radiator described herein also achieves significantly less variance over manufacturing tolerances than that achieved with the patch radiator.

Additionally, a current loop radiator described herein on oversized rectangular lattice achieves superior loss performance and maintain axial ratio performance near, at, and beyond grating lobe incidence better than prior art radiator designs, such as patch radiators. The grounded structure of the current loop described herein suppresses the scan blindness that typically causes large gain drops and impedance mismatch at and near grating lobe incidence. Further, the current loop radiator described herein can achieve axial ratio of less than 2 dB to be achieved out to 50-degree scan in both E- and H-Planes without any need for amplitude and phase adjustments between the linear components forming right hand circular polarization (RHCP). Because of this it is possible to cut the number of monolithic microwave integrated circuit (MIMIC) chips in half, saving significant cost and power without sacrificing receiver (RX) performance. An improvement in power and cost is possible for a transmitter (TX) (compressed) operation, but, in that case, halving the number of MIMIC chips reduces the effective isotropic radiated power (EIRP) by 3 dB all other things remaining the same.

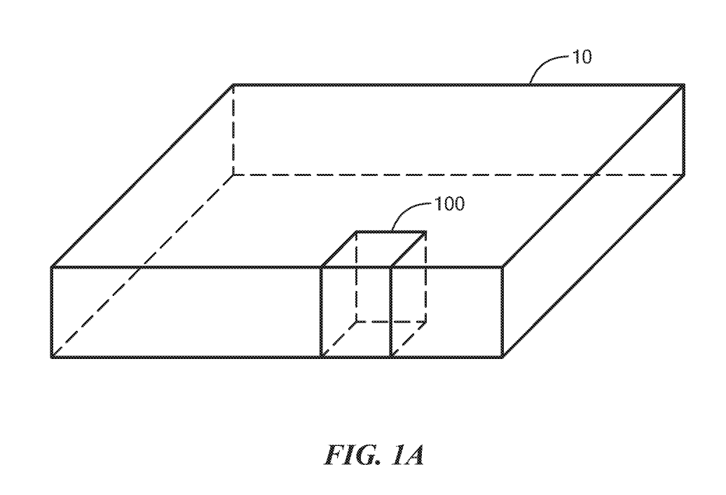

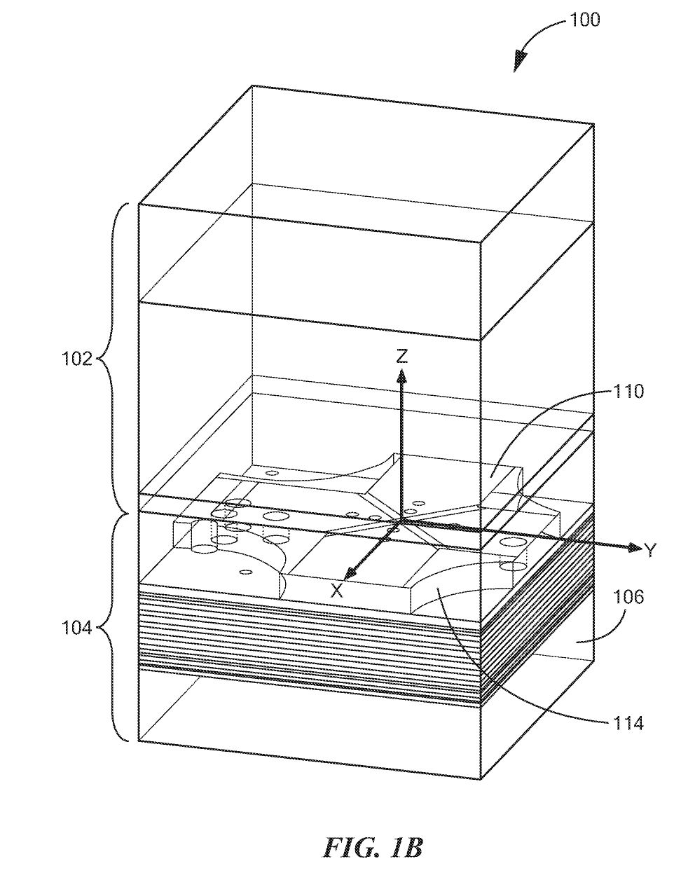

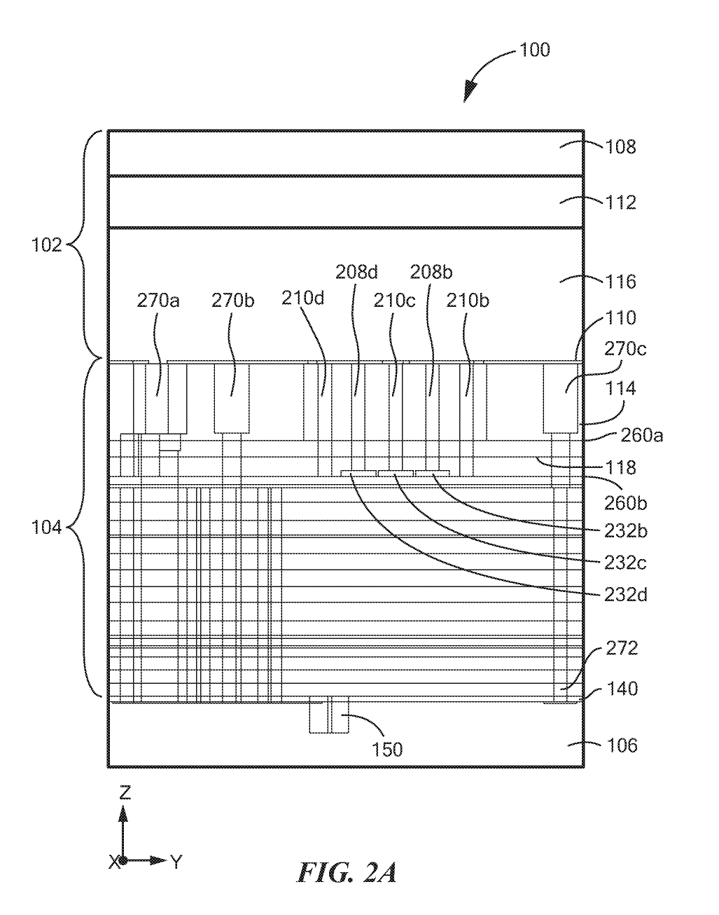

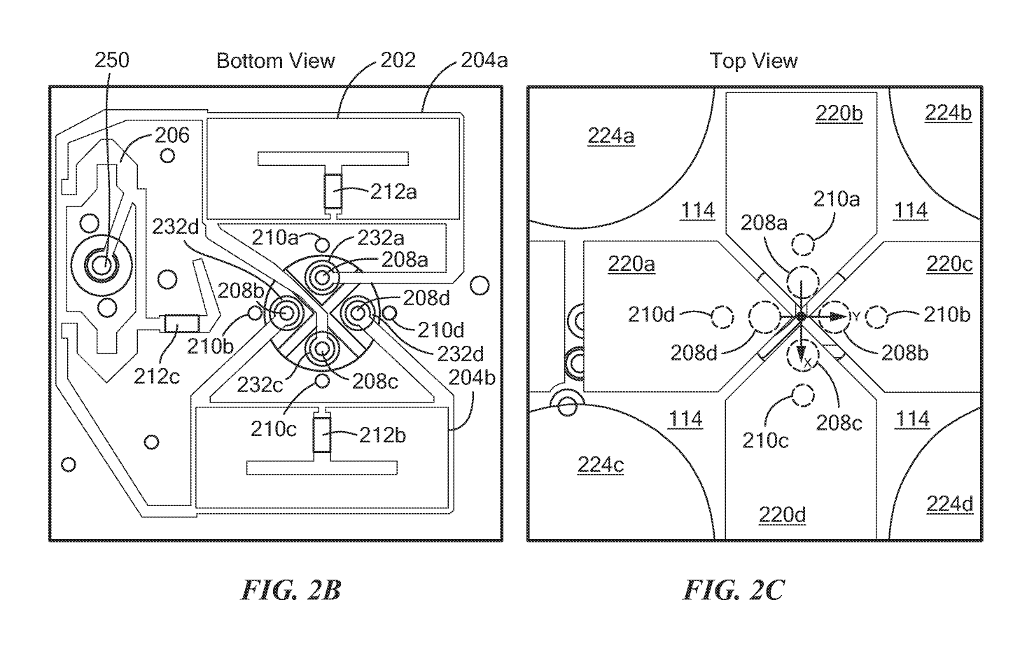

Referring to FIGS. 1A and 1B, a phased array antenna 10 includes unit cells (e.g., a unit cell 100). In some examples, the phased array antenna 10 may be shaped as a rectangle, a square, an octagon and so forth. The unit cell 100 comprises a radome portion 102, a printed wiring board (PWB) 104 and an active layer 106 where active components are attached to layer 140 as shown in FIG. 2A. The PWB 110 includes a radiator 110 that is disposed on a dielectric 114.

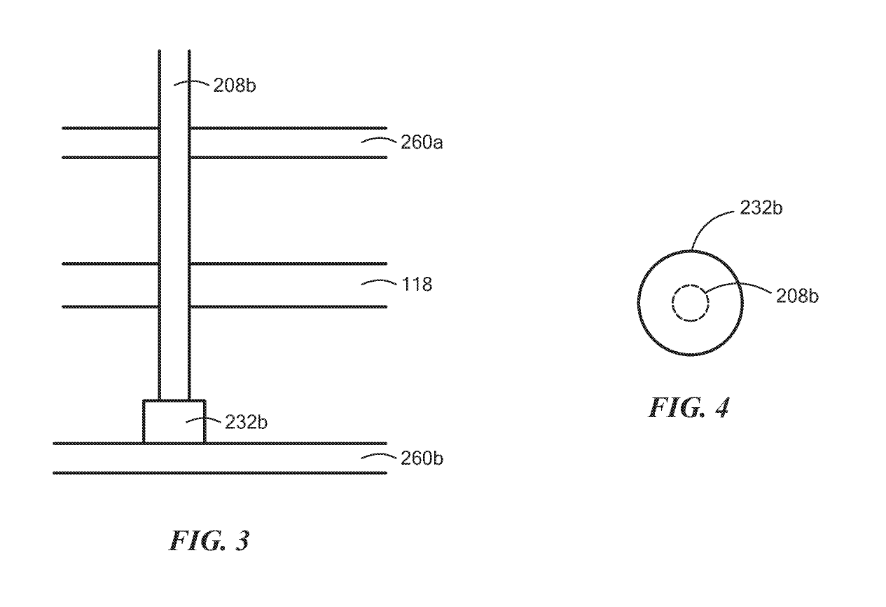

Referring to FIGS. 2A to 2C, 3 and 4 the radome 102 includes a wide-angle impedance matching (WAIM) layer 112 between two air layers 108, 116. The active layer 104 includes air and active components 150 attached to the PWB 104 on layer 140.

The PWB 104 includes a radiator layer 110. The radiator layer 110 includes a radiator having four dipole arms (e.g., a dipole arm 220a, a dipole arm 220b, a dipole arm 220c and a dipole arm 220d). The dipole arms 220a-220d are excited by a feed circuit 202 (FIG. 2B) located at the feed layer 118 using vias. In one example, each dipole arm 220a-220d is connected to the feed layer by a corresponding via that extends through the dielectric 114. For example, the dipole arm 220a is connected to the feed circuit 202 by a via 208a, the dipole arm 220b is connected to the feed circuit 202 by a via 208b, the dipole arm 220c is connected to the feed circuit 202 by a via 208c, and the dipole arm 220d is connected to the feed circuit 202 by a via 208d.

Vias 208a-208d are backdrilled and filled with backdrill fill material to prevent the vias-208a-208d from connecting to the ground plane 260b. For example, the via 208a is backdrilled from layer 260b and then filled with backdrill material 232a, the via 208b is backdrilled from layer 260b and then filled with backdrill material 232b, the via 208c is backdrilled from layer 260b and then filled with backdrill material 232c and the via 208d is backdrilled from layer 260b and then filled backdrill material 232d. The backdrills of these four vias 208a-208d are done in the same processing step and the filling of the four vias 208a-208d is also done in one processing step. The spacing between the radiator layer 110 and a ground plane 260a is typically around an eighth of a wavelength (so that with the image it is effectively a quarter wavelength) in the material (dielectric 114) between the radiator layer 110 and the ground plane 260a. In one example, the backdrill fill material is a permanent plug hole plugging ink such as PHP900 permanent hole plugging ink by San-El Kagaku Co. LTD.

Each of the dipole arms 220a-220d is grounded to the ground plane 260a, 260b by a corresponding via. For example, the dipole arm 220a is grounded using a via 210a, the dipole arm 220b is grounded using a via 210b, the dipole arm 220c is grounded using a via 210c and the dipole arm 220d is grounded using a via 210d. In one example, one or more of the vias 210a-210d are added at a particular distance from a respective via 208a-208d to control tuning.

The PWB 104 may also include other vias (e.g., a via 272) that extend through the PWB 104. The PWB 104 includes other backdrill operations and backfill material. For example, the dielectric 114 includes backdrilled material 270a-270c. The purpose of the backdrill fill material is to fill the hole created by the backdrill operation that separates the through vias from ground, which is done to simplify board construction by allowing more layer to layer connections to be made for a given number of laminations. The backdrill separates the via from the outer layers, but creates an exposed hole. This hole is filled with backdrill fill material (e.g., PHP900 by SAN-EI KAGAKU CO., LTD). That material is often plated over to provide electrical shielding.

In one example, the feed circuit 202 is a quadrature phase feed circuit. The feed circuit 202 includes a rat-race coupler 204a connected to the dipole arm 220a using the via 208a and the dipole arm 220c using the via 208c and a rat-race coupler 204b connected to the dipole arm 220b using the via 208b and the dipole arm 220d using the via 208d. The signals to the dipole arms 220a, 220c are 180° out of phase from one another and the signals to the dipole arms 220b, 220d are 180° out of phase from one another. In one example, the signals to the dipole arms 220a, 220b are 90° out of phase from one another and the signals to the dipole arms 220c, 220d are 90° out of phase from one another. In one particular example, the feed circuit 202 provides signals to the dipole arms 220a-220d using right hand circular polarization (RHCP).

The feed circuit 202 also includes a branch coupler 206 that connects to the rat-race couplers 204a, 204b. The rate race-coupler 202a includes a resistor 212a, the rat-race coupler 202b includes a resistor 212b and the branch coupler 206 includes a resistor 212c. The resistors 212a-212c provide isolation between the first rat-race coupler 202a, the second-rat-race coupler 202b and the branchline coupler 206, which improves scan performance. The branch coupler 206 is connected to a via 272, which is connected to a signal layer 140 where the active devices 150 are connected. In other examples, other methods of RF connection within the PWB may be used to connect the feed circuit 202 to the signal layer 140.

Portions of the dielectric 114 are removed to improve scan performance. In one example, a 0.25-inch drill is used to drill four holes 224a-224d to remove the dielectric 114.

The radiator can be tuned in several ways to optimize frequency of operation, polarization characteristics, and scan volume. Tuning features include via locations, dielectric constant and material thickness, pattern of the radiator circuit, spacing of the feed vias, and design of the feed circuitry. For some applications, control depth drills may be used the selectively remove dielectric material between the radiator circuit and the backplane to improve performance. The use of through metallized vias and control depth drills is also used to achieve connect the ground of the radiator and feed layer to the grounds of the CCA. This simplifies PWB construction and helps avoid the use of more expensive technology such as separate PWBs that require connectors or other interconnect components. The location and size of drills can be used as tuning features. Tightly coupled parasitic tuning elements can also be used near the radiator circuit layer for some designs to improve performance and/or reduce the depth of the radiator. The current loop feature such being low profile and being a well-grounded structure allows the current loop to offer improved grating lobe performance.

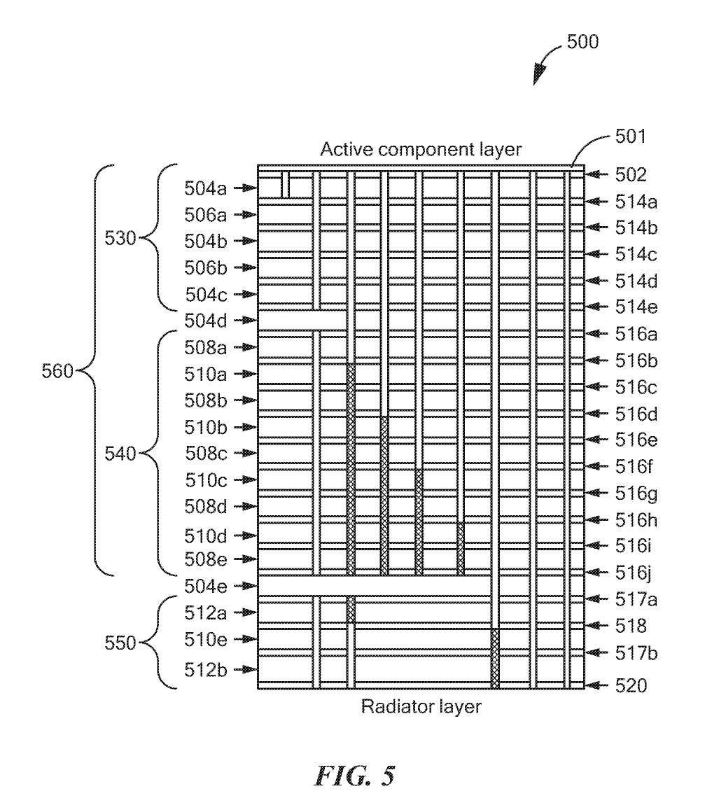

Referring to FIG. 5, an example of a PWB 104 is a PWB 500. In one example, the materials to fabricate the PWB 500 are materials compatible with FR4 processing. The PWB 500 includes a solder mask layer 501, a microstrip signal layer 502, stripline layers 516a-516j, power/ground layers 514a-514e, ground planes 517a-517b, a stripline feed signal layer 518. In this example, the feed layer is in the stripline signal layer 518 (e.g., feed circuit 202 (FIG. 2B) and the radiator layer is in the signal/patch layer 520. In this example, active components (e.g., active component 150) are bonded to the microstrip signal layer 502.

In one example, the solder mask 501 is a patterned LPI solder mask. In one example, the microstrip signal layer 502 includes copper and gold plating. In one example, the signal layers include copper. In one example, the power/ground layers include copper or copper plating. In one example, the stripline signal layer 518 includes Ticer TCR25 OPS (The manifold stripline layers 516a-516j may also have TICER TCR 25 OPS). In one example, the signal/patch layer 520 includes copper and silver plating.

Interposed between the metal layers are first material layers 504a-504e, second layers 506a-506b, third material layers 508a-508e, fourth material layers 510a-510e and fifth material layers 512a-512b. The PWB 500 also includes vias (e.g., a metal via 550) extending through the layers. Some of the vias include backfill material 552.

In one example, the first material layers 504a-504e are a phenyl ether blend resin material such as, for example, Megtron 6 manufactured by Panasonic. In one example, the second material layers 506a-506b are a high frequency laminate such as, for example, RO4360G2 manufactured by Rogers Corporation. In one example, the third material layers 508a-508e are a laminate, such as, for example, R04350B manufactured by Rogers Corporation. In one example, the fourth material layers 510a-510e are a bond ply, such as, for example, RO4450F manufactured by Rogers Corporation. In one example, the fifth material layers 512a-512b are a laminate, such as, for example, RO4003 manufactured by Rogers Corporation.

Care is taken in stackup formation to reduce the number of laminations required in the PWB build to reduce cost and complexity. Additionally, the choice of prepregs in the PWB stackup has been developed to allow for higher number of laminations to help minimize producibility risks. The use of FR4 processing compatible materials is used to allow for high aspect ratio vias and reduced cost in fabrication. Because of these developments, no connectors and additional assembly is required to connect the radiator to the CCA. It achieves low cost, low profile, simple integration in a manner like the patch radiator, but with improved performance due to its lower Q nature.

In one example, the layers 501, 502, 504a-504c, 506a-506b, 514a-514e are laminated together to form substructure 530. The layers 508a-508e, 510a-510d, 516a-516j are laminated together to form a substructure 540. The layers 510e, 512a-512b, 517a, 517b, 518, 520 are laminated together to form the substructure 550. The substructure 530 is laminated to the substructure 540 using the layer 504d to form a substructure 560. The substructure 560 is laminated to the substructure 550 using the layer 504e to form the PWB 500.

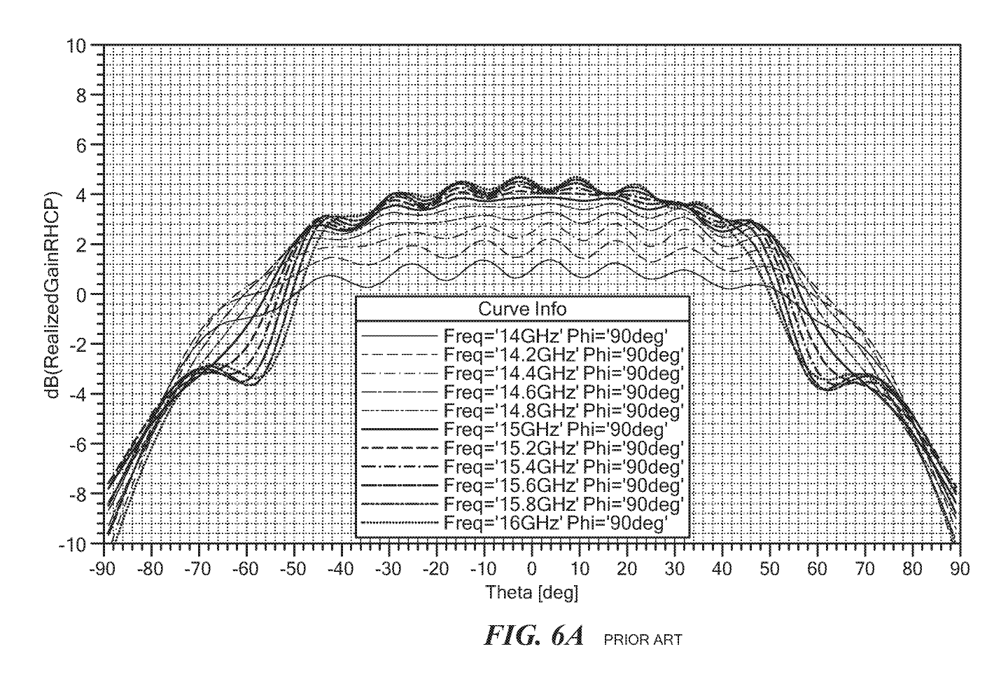

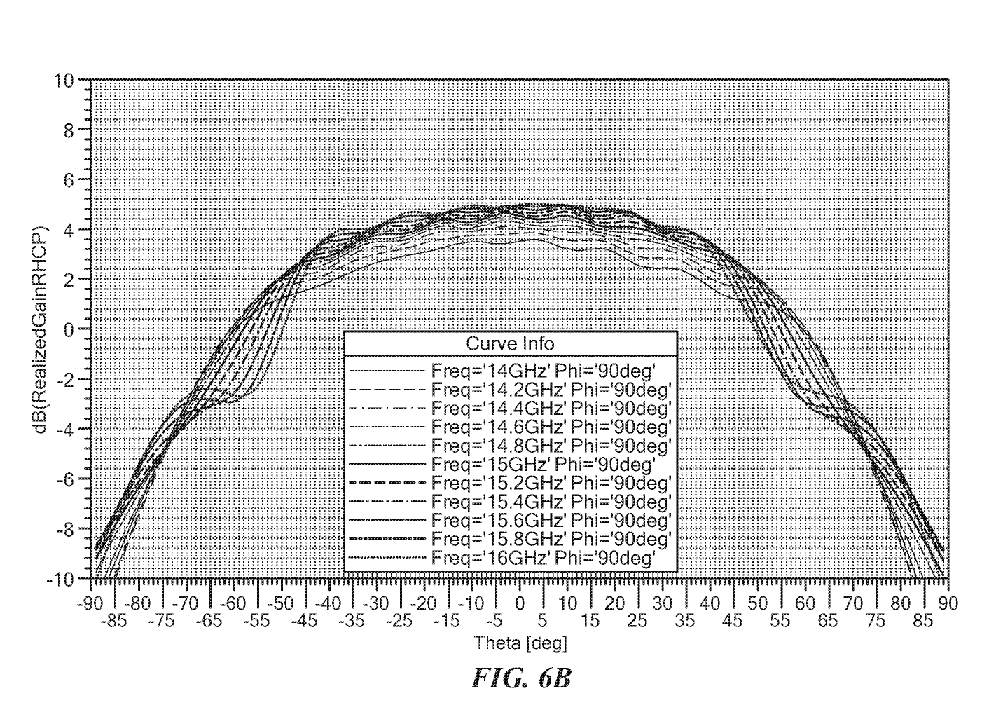

Referring to FIGS. 6A and 6B, the unit cell 100 is a significant improvement from the patch radiator in realized gain. In FIG. 6A, the realized gain for a patch radiator may vary by more than 4 db. In FIG. 6B, the realized gain of the unit cell 100 varies by only 2 db.

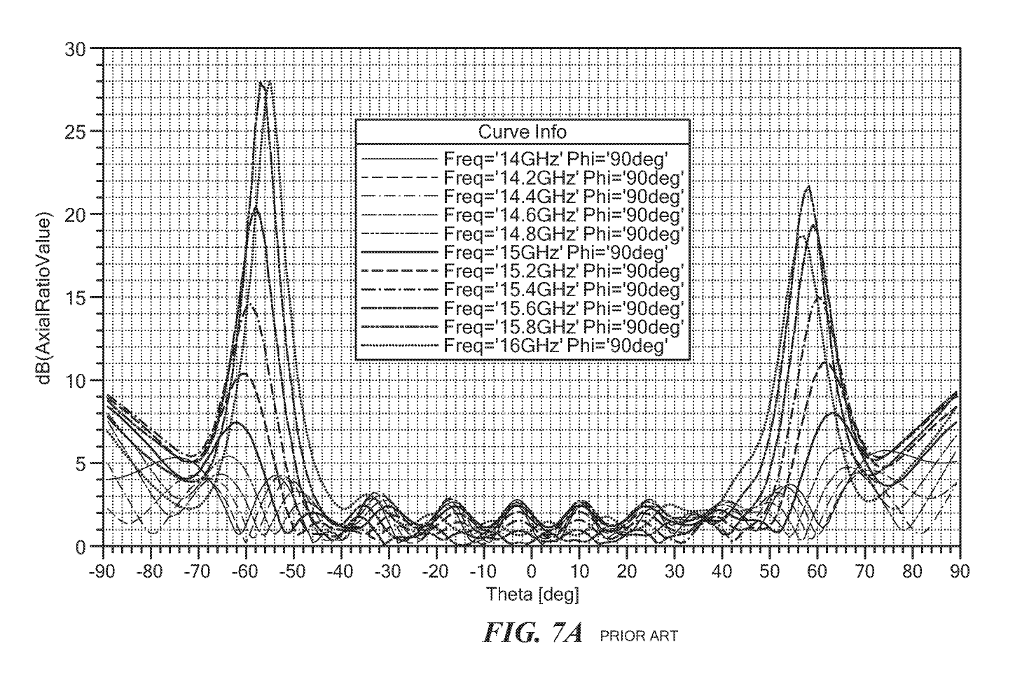

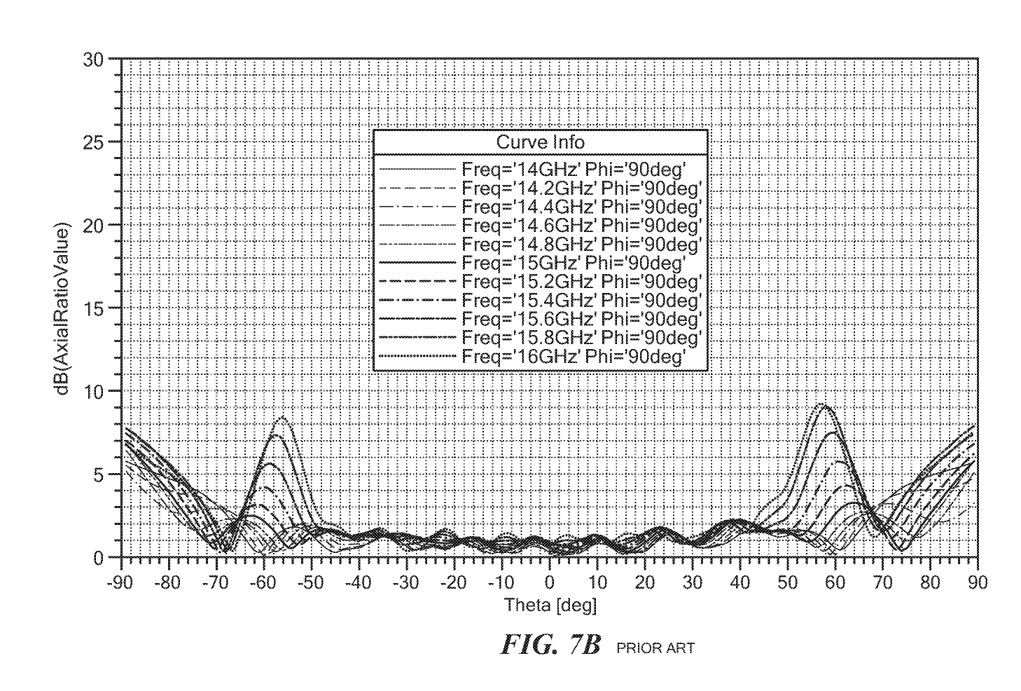

Referring to FIGS. 7A and 7B, the unit cell 100 is a significant improvement from the patch radiator in axial ratio value near the grating lobes. In FIG. 7A, for the patch radiator, the axial ratio value, at about + or −60 degrees, is more than 20 db. In FIG. 7B, for the unit cell 100, the axial ratio value, at about + or −60, degrees is less than 10 db.

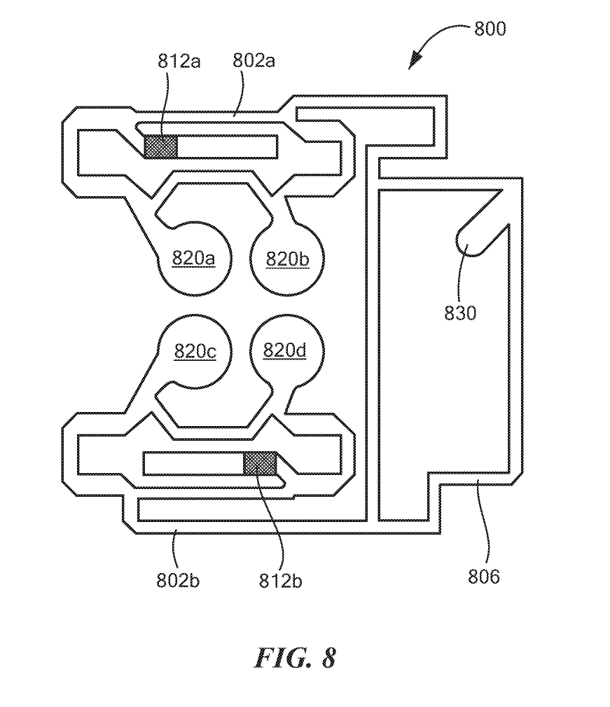

Referring to FIG. 8, another example of a feed circuit is the quadrature feed circuit 800. The feed circuit includes branch couplers 802a, 802b coupled to a rat-race coupler 806. The branch coupler 802a includes pads 820a, 820b and a resistor 812a and the branch coupler 802b includes pads 820c, 820d and a resistor 812b. The pads are connected to a corresponding one of the radiator dipole arms 220a-220d to provide 0°, 90°, 180°, 270° excitation of the radiator. The rat-race coupler 806 includes a pad 830, which connects to a coaxial port to receive signals. In one example, the difference in phase between the signals provided to pads 820a, 820b is 90° and the difference in phase between the signals provided to pads 820c, 820d is 90°.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A unit cell of a phased array antenna comprising:
a printed wiring board (PWB) comprising:
a first layer comprising a radiator;
a second layer comprising a feed circuit configured to provide excitation signals to the radiator;
a plurality of vias connecting the feed circuit to the radiator;
a signal layer;
an active component layer comprising an active component bonded to the signal layer; and
a radio frequency (RF) connector connecting the signal layer to the feed circuit.

2. The unit cell of claim 1, wherein the radiator comprises:
a first dipole arm;
a second dipole arm;
a third dipole arm; and
a fourth dipole arm.

3. The unit cell of claim 2, wherein the plurality of vias comprises:
a first via coupled to the first dipole arm;
a second via coupled to the second dipole arm;
a third via coupled to the third dipole arm and
a fourth via coupled to the fourth dipole arm,
wherein the first, second, third and fourth vias provide the excitation signal from the feed circuit.

4. The unit cell of claim 3, wherein the feed circuit comprises:
a first rat-race coupler coupled to the first via and the third via;
a second rat-race couple coupled to the second via and the fourth via;
a branchline coupler coupled to the first and second rat race couplers.

5. The unit cell of claim 4, wherein signals to the first and third dipole arms are 180° out of phase from one another. and
wherein signals to the second and fourth dipole arms are 180° out of phase from one another.

6. The unit cell of claim 5, wherein signals to the first and second dipole arms are 90° out of phase from one another, and
wherein signals to the third and fourth dipole arms are 90° out of phase from one another.

7. The unit cell of claim 3, wherein the feed circuit further comprises:
a first resistor coupled to the first rat-race coupler;
a second resistor coupled to the second rat-race coupler; and
a third resistor coupled to the branchline coupler,
wherein the first, second and third resistors provide isolation between the first rat-race coupler, the second-rat-race coupler and the branchline coupler.

8. The unit cell of claim 3, further comprising:
a fifth via coupled to the first dipole arm;
a sixth via coupled to the second dipole arm;
a seventh via coupled to the third dipole arm and
an eighth via coupled to the fourth dipole arm,
wherein the fifth, sixth, seventh and eighth vias provide ground.

9. The unit cell of claim 1, wherein the feed circuit is a quadrature phase feed circuit.

10. The unit cell of claim 1, wherein the feed circuit supplies signals to the radiator using right hand circular polarization (RHCP).

11. The unit cell of claim 1, wherein the PWB further comprises a third layer between the first and second layers, and
wherein the third layer comprises a dielectric.

12. The unit cell of claim 1, wherein the dielectric comprises four rounded corners evenly spaced around the dialectic.

13. The unit cell of claim 12, wherein the four rounded corners are formed using a 0.25-inch drill bit.

14. The unit cell of claim 1, wherein the RF connector is a via.

15. The unit cell of claim 1, further comprising a radome comprising a wide-angle impedance matching (WAIM) layer.

16. The unit cell of claim 2, wherein the radiator comprises:
a first dipole arm;
a second dipole arm;
a third dipole arm; and
a fourth dipole arm, and
further comprising:
a first via coupled to the first dipole arm;
a second via coupled to the second dipole arm;
a third via coupled to the third dipole arm and
a fourth via coupled to the fourth dipole arm,
wherein the first, second, third and fourth vias provide the excitation signal from the feed circuit,
wherein the feed circuit comprises:
a first branchline coupler coupled to the first via and the second via;
a second branchline couple coupled to the third via and the fourth via;
a rat-race coupler coupled to the first and second branchline couplers.

17. A unit cell of a phased array antenna comprising:
a printed wiring board (PWB) comprising:
a first layer comprising a radiator comprising:
a first dipole arm;
a second dipole arm;
a third dipole arm; and
a fourth dipole arm;
a second layer comprising a quadrature feed circuit configured to provide excitation signals to the radiator using right hand circular polarization (RHCP);
a first via coupled to the first dipole arm;
a second via coupled to the second dipole arm;
a third via coupled to the third dipole arm and
a fourth via coupled to the fourth dipole arm, wherein the first, second, third and fourth vias provide the excitation signal from the feed circuit,
a fifth via coupled to the first dipole arm;
a sixth via coupled to the second dipole arm;
a seventh via coupled to the third dipole arm and
an eighth via coupled to the fourth dipole arm, wherein the fifth, sixth, seventh and eighth vias provide ground.
a third layer between the first and second layers, wherein the third layer comprises a dielectric having four rounded corners evenly spaced around the dialectic.

18. The unit cell of claim 17, further comprising:
an active component layer comprising an active component bonded to the PWB; and
a radome comprising a wide-angle impedance matching (WAIM) layer.

19. A unit cell of a phased array antenna comprising:
a printed wiring board (PWB) comprising:
a first means for providing a radiated signal;
a second means for generating excitation signals; and.
a third means for providing the excitation signals from the second means to the first means.

20. The unit cell of claim 19, further comprising a fourth means for providing grounding to the first means.
